(19) United States
(12) Patent Application Publication
(10) Pub. No.: US 2009/0257484 A1
(43) Pub. Date: Oct. 15, 2009

(54) METHOD FOR AUDIO-VIDEO ENCODING AND APPARATUS FOR MULTIMEDIA STORAGE

(75) Inventor: Shu-Hui Liu, Taoyuan County (TW)

Correspondence Address: J C PATENTS, 4 VENTURE, SUITE 250, IRVINE, CA, 92618, US

(73) Assignee: WINBOND ELECTRONICS CORP., Hsinchu (TW)

(21) Appl. No.: 12/103,187

(22) Filed: Apr. 15, 2008

(51) Int. Cl. H04N 11/02

(52) U.S. Cl. 375/240.01; 375/E07.076

(57) ABSTRACT

The invention relates a method for audio-video encoding and an apparatus for multimedia storage. First, a video chunk and an audio chunk are read from a audio-video file. Then the video chunk is divided into a plurality of video blocks, wherein size of each video block at least equals to the size of one unit frame. The audio chunk is divided into a plurality of audio blocks. Finally, according to a playing sequence, at least one audio block is employed between each two video blocks.

### BACKGROUND OF THE INVENTION

1. Field of the Invention

The present invention relates to an audio-video processing technique. More particularly, the present invention relates to a technique for encoding an audio-video file.

2. Description of Related Art

With development of multimedia technique, various audio-video formats such as asf, mpg, wmv and audio video interleave (AVI) are applied. Moreover, watching movies or programs via a computer is popular presently. As to the window operating system of the computer, it contains various codec programs which may decode audio-video files with different formats, so that the computer may play the audio-video files with various formats.

In a general embedded system with limited resources, various codecs may not be included therein, and therefore decoding of the audio-video files cannot be performed as that does in a general computer. However, to play the audio-video files with different formats, software tools may be utilized by the embedded system to transform the audio-video files with different formats into the files with the AVI format, then to decode and play the transformed audio-video files. However, since the transformed AVI audio-video files has to be stored by the embedded system, memory with a large volume is required for storing the AVI audio-video files, and therefore cost of hardware will be huge.

Moreover, since the transformed AVI audio-video file includes a plurality of video chunks and audio chunks, and the video chunk contains video data including a plurality of frames, and the video chunks and the audio chunks have to be processed by the embedded system for being played, under limited hardware conditions, processing speed of the video chunks and the audio chunks by the embedded system is limited, which may leads to a delay problem during play of the audio-video files.

### SUMMARY OF THE INVENTION

The present invention is directed to an audio-video encoding method, by which video chunks and audio chunks within an audio-video file are divided into relatively small blocks, so as to reduce utilization volume of a memory.

The present invention is directed to a multimedia storage apparatus, which is used for storing encoded audio-video files and improving an audio-video processing speed.

The present invention provides an audio-video encoding method. The method is as follows. First, an audio-video file is provided. Next, a video chunk and a corresponding audio chunk within the audio-video file are read. Next, the video chunk is divided into a plurality of video blocks, wherein size of each of the video blocks at least equals to the size of one unit frame. Next, the audio chunk is divided into a plurality of audio blocks. Next, a sound sampling rate and a frame rate of the audio-video file are read. Next, an audio configuration parameter is calculated, wherein the audio configuration parameter equals to the sound sampling rate divided by the flame rate. Next, a specific number is determined according to a rated value of the audio blocks and the audio configuration parameter. Finally, the audio blocks with the specific number are employed between each two video blocks according to a playing sequence.

The present invention provides a multimedia storage apparatus for storing an encoded audio-video file including a plurality of video blocks, a plurality of audio blocks, a header and a plurality of indexes. Wherein, the header of the audio-video file records sets data of the video blocks and the audio blocks, and the indexes respectively point to addresses of the video blocks and the audio blocks. Moreover, one of the audio blocks is employed between each two video blocks, and each of the video blocks contains the same number of frames, and audio data within each audio block is substantially equivalent to audio data corresponding to a previous video block.

According to the audio-video encoding method of the present invention, the video chunk and the audio chunk within the audio-video file are divided into a plurality of the small blocks, so that memory volume of a follow-up circuit may be reduced, and video processing speed is improved.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a flowchart illustrating a audio-video encoding method according to an embodiment of the present invention.

FIG. 2(a) is a structural schematic diagram of an original audio-video file.

FIG. 2(b) is a structural schematic diagram of a divided audio-video file.

FIG. 3 is a block diagram illustrating an audio-video encoding module according to an embodiment of the present invention.

FIG. 4 is a flowchart illustrating sub-steps of the step S150.

### DESCRIPTION OF EMBODIMENTS

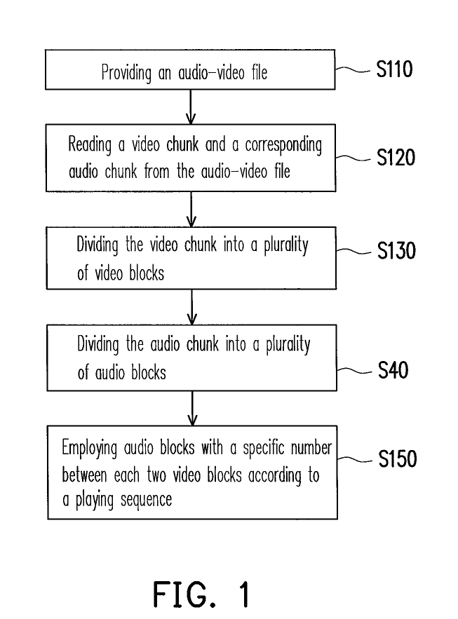

In order to conveniently illustrate this embodiment, the following assumptions are made. First, assuming an audio-video encoding method is applied to a multimedia storage apparatus, and assuming the multimedia storage apparatus may play an audio-video file with an audio video interleave (AVI) format. FIG. 1 is a flowchart illustrating an audio-video encoding method according to an embodiment of the present invention.

Referring to FIG. 1, first, an audio-video file is provided (step S110), the audio-video file may be a file received by the multimedia storage apparatus, or may be a transformed audio-video file. In the present embodiment, the audio-video file is an AVI audio-video file. Next, the multimedia storage apparatus reads a video chunk and a corresponding audio chunk from the audio-video file (step S120). Taking a present AVI audio-video file as an example, according to the AVI format, video data and audio data within the AVI audio-video file are divided into a plurality of chunks, and the video chunk and the audio chunk may be transmitted via interleaving transmission. Here, the interleaving transmission data may be referred to as multiplexed media data.

Next, the video chunk is divided into a plurality of video blocks by the multimedia storage apparatus (step S130), wherein size of each divided video block at least equals to the size of one unit frame. For convenience, assuming each frame is a video block. In other words, in the step S130, the video chunk is divided into a plurality of the video blocks according to the size of each frame data. Next, after the video chunk is divided, the audio chunk is divided into a plurality of audio blocks by the multimedia storage apparatus (step S140). Finally, audio blocks with a specific number are employed between each two video blocks according to a playing sequence (step S150). In the present embodiment, each video block may be one frame, and audio blocks with the specific number employed between each two video blocks may be the audio data corresponding to previous video block (frame). In the present embodiment, the specific number can be determined in advance, and it means the number of the audio blocks between each two video blocks.

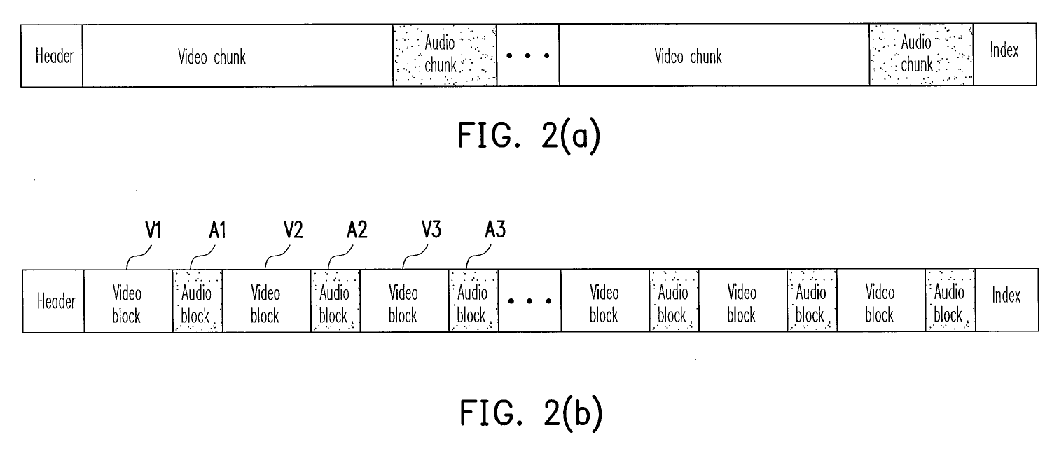

According to the above encoding method, video chunk and the audio chunk within the original AVI format audio-video file are divided into a plurality of the small blocks. FIG. 2(a) and FIG. 2(b) are diagrams respectively illustrating an original audio-video file and a divided audio-video file. Referring to FIG. 2(a), the original AVI format audio-video file includes a header, a video chunk, an audio chunk and an index. Wherein, the header is recorded with setting data of the video chunk and the audio chunk, such as frame number of the video chunk, frame rate, video bit rate, sound sampling rate and sound classification of stereo or mono etc. The video chunk includes a plurality of frame data, and the audio chunk is sound signals corresponding to the video chunk. The index of FIG. 2(a) is used for pointing to addresses of the video chunk and the audio chunk within the multimedia storage apparatus.

Referring to FIG. 2(b), the audio-video file processed by the aforementioned encoding method includes a header, a plurality of video blocks V1˜V3, a plurality of audio blocks A1˜A3 and an index. Wherein, the header is recorded with setting data of the video blocks V1˜V2 and the audio blocks A1˜A3. The plurality of video blocks V1˜V3, for example, are divided from the video chunk may based on a frame size. The plurality of audio blocks A1˜A3 is a plurality of small blocks divided from the audio chunk, and data of the audio blocks A1˜A3 are the audio data respectively corresponding to the video blocks V1˜V3. For example, the audio block A1 is the audio data corresponding to the video block V1. The index of the FIG. 2(b) is used for pointing to the addresses of the video blocks V1˜V3 and the audio blocks A1˜A3 within the multimedia storage apparatus.

According to FIG. 2(b), a main structure of the audio-video file is to divide the original video chunk and the audio chunk into a plurality of the small blocks, and the format of the original audio-video file is not changed. Namely, the audio-video file processed by the aforementioned encoding method may still have the AVI format. Therefore, adding of extra hardware to process the encoded audio-video file is unnecessary in the present embodiment. Moreover, when the multimedia storage apparatus plays the audio-video file of FIG. 2(b), a memory with relatively small volume may be utilized to store a part of the video blocks and the audio blocks, and then the stored video blocks and audio blocks may be played after being processed by video processing. For example, the video block V1 and the audio block A1 are first stored into the multimedia storage apparatus, and then the video block V1 and the audio block A1 are processed. Next, the video block V2 and the audio block A2 are stored into the multimedia storage apparatus, and then the video block V2 and the audio block A2 are processed. Therefore, according to the audio-video encoding method of the present invention, storage of the whole video chunk and the audio chunk is unnecessary, and requirement of the memory volume is reduced. Moreover, since each time the multimedia storage apparatus only needs to process a small amount of the video blocks and the audio blocks, the multimedia storage apparatus with a slow processing speed may also play the audio-video file smoothly.

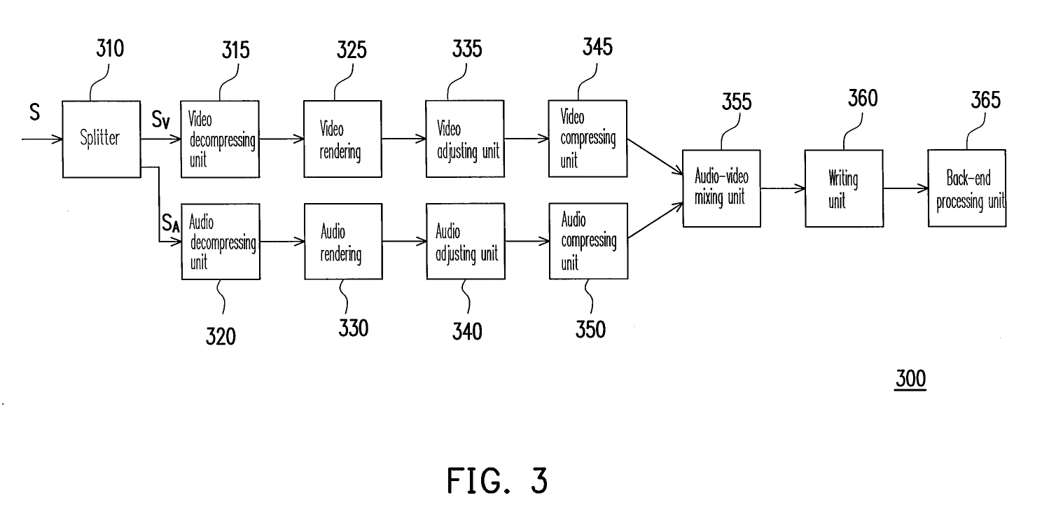

Since a general multimedia storage apparatus is required to be capable of playing the audio-video files with various formats, to fully convey the spirit of the present invention to those skilled in the art, another apparatus is provided. FIG. 3 is a block diagram illustrating an audio-video encoding module according to an embodiment of the present invention. Referring to FIG. 3, first, an audio-video encoding module 300 receives a audio-video file S, wherein the format of the audio-video file S may be asf, mpg, wmv or AVI etc. A splitter 310 receives the audio-video file S and splits the audio-video file S into a video data S_{V} and an audio data S_{A}, and respectively outputs the video data S_{V} and the audio data S_{A} to a video decompressing unit 315 and an audio decompressing unit 320. Next, the video data S_{V} is sequentially decompressed by the video decompressing unit 315 to form an original video data, and then the original video data is reprocessed by a video processing technique via a video rendering 325. Thereafter, a video adjusting unit 335 then adjusts an output data of the video rendering 325, wherein an adjusting method thereof is to extract several frames within one second, and enlarge or reduce sizes of the frames for adjusting the size and encoding quality of the video data. After the video adjusting unit 335 adjusts the video data, a video compressing unit 345 then encodes the video data and outputs the encoded video data to a audio-video mixing unit 355.

Processing method of the audio data S_{A} is similar to that of the video data S_{V}, and therefore repeated description thereof is omitted. However, the difference of the two processing methods is that an audio adjusting unit 340 may adjust the sound sampling rate and adjust the audio data to be stereo or mono. Next, the audio-video mixing unit 355 receives the video data and the audio data respectively encoded by the video compressing unit 345 and an audio compressing unit 350, and mixes the video data and the audio data for outputting to a writing unit 360. The writing unit 360 then writes an audio-video format to the output data of the audio-video mixing unit 355. The audio-video encoding module 300 of the present embodiment is mainly used for transforming the audio-video files with different formats into files that the multimedia storage apparatus may play. In the present embodiment, assuming the audio-video format that the multimedia storage apparatus may play is AVI 2.0 format. Therefore, the video compressing unit 345 and the audio compressing unit 350 may compress the data to be data matched to the AVI 2.0 format, and the writing unit 360 may writes the data with the AVI 2.0 format into an AVI 2.0 data structure.

The audio-video file output from the writing unit 360 may be the AVI 2.0 audio-video file, and such audio-video file may include a video chunk and an audio chunk, as shown in FIG. 2(a). Thereafter, a follow-up processing unit 365 re-encodes the audio-video file output from the writing unit 360 by the audio-video encoding method provided by the embodiment of FIG. 1, and outputs an audio-video file with the AVI format. The processing method of the follow-up processing unit 365 is similar to that of the embodiment of FIG. 1, and therefore the description thereof is not repeated.

According to the above embodiment, the multimedia storage apparatus first applies a developed application software (such as DirectX 9.0) to transform the audio-video file with different formats into the audio-video file with the AVI format, and then applies the audio-video encoding method provided by the present invention to re-encode the audio-video file with the AVI format (i.e. processed by the follow-up processing unit 365 of FIG. 3) and outputs the re-encoded audio-video file to a next circuit. By such means, utilization of the memory volume is reduced, and processing speed thereof is improved.

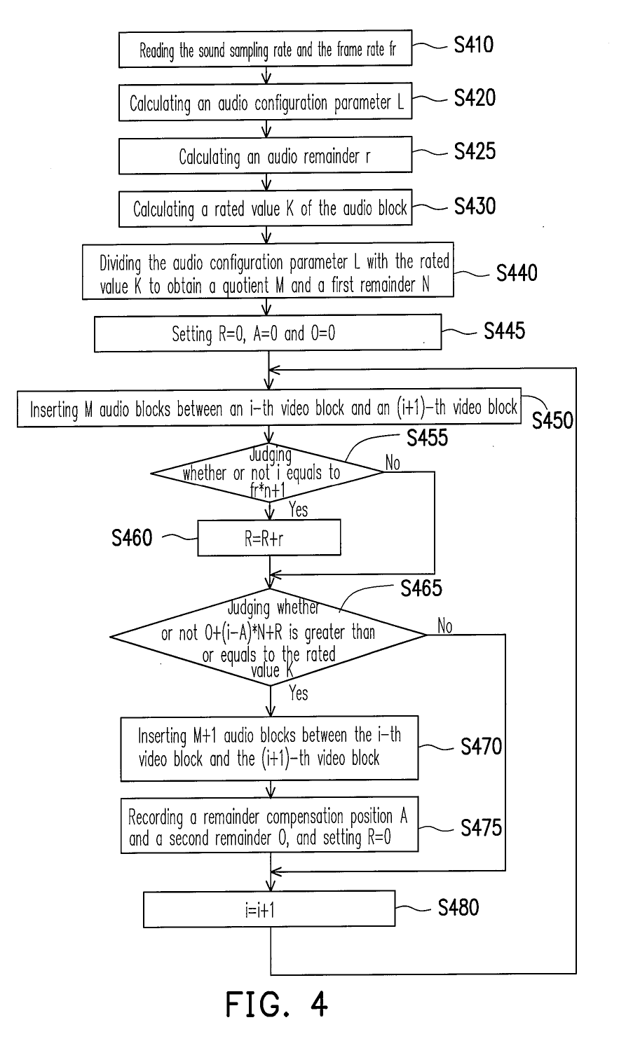

In the following content, how to employ the audio blocks between the video blocks so as to smoothly play the audio-video is further described. FIG. 4 is a flowchart illustrating sub-steps of the step S150. Referring to FIG. 4, first, the sound sampling rate and the frame rate recorded on the header of the audio-video file are read (step S410). Here, for convenience, the frame rate is represented by fr hereinafter. Next, an audio configuration parameter is calculated (step S420), which is represented by L hereinafter. Next, and an audio remainder is calculated (step S425), which is represented by r, wherein the audio configuration parameter L equals to a quotient of the audio sampling rate divided by the frame rate, and the audio remainder r equals to a remainder of the audio sampling rate divided by the frame rate. In the present embodiment, assuming the sampling rate of the audio blocks is 11kHz, i.e. 11025 samples/second, and the frame rate fr is 10 frames/second. The audio configuration parameter L then equals to 11025/10=1102, and the audio remainder r=5 is then generated. The audio configuration parameter L represents the audio sample number matched to each frame data. However, if the 10 frames is matched with the 11025 audio samples within one second, r=5 audio samples are still remained. For convenience, n is used for representing time (second) index, wherein n=0, 1, 2, . . . . Now, assuming the audio samples of the first second is processed. Namely, now n=0.

Next, a rated value of the audio block is calculated (step S430), wherein the rated value represents the samples included within one audio block, and is represented by K. In the present embodiment, to cope with the AVI format of the Microsoft, there has a fixed calculation method for the rated value of the audio block. In accordance with the Microsoft regulations, byte number (which is represented by B hereinafter) of each audio block may be 256 or 512 etc. If the audio signal is stereo, the rated value K then equals to (B/2−4)*2+1. If the audio signal is mono, the rated value K then equals to (B−4)*2+1. Here, assuming the audio signal is mono, and the byte number B of each audio block equals to 256, the rated value K then equals to 505 according to the above calculation method.

Next, a quotient (represented by M) and a first remainder (represented by N) are obtained by dividing the audio configuration parameter L with the rated value K (step S440). According to the above assumption, L/K=1102/505, and M=2 and N=92 are then obtained. The quotient M=2 represents that M=2 audio blocks are required to be matched to each video block, though N=92 audio samples are still remained. Next, initial values of R, A and O are set to 0 (step S445), wherein definition and physical meaning of the parameters R, A and O are described in the following content.

After the step S445, values of L, K, M and N are calculated. Next, the audio blocks are then inserted among the video blocks. According to the above parameter M, M=2 audio blocks are inserted between an i-th video block and an (i+1)-th video block (step S450), wherein i is a positive integer, and an initial value of i is 1. In other words, now i=1, and 2 audio blocks are employed between a first video block and a second video block.

However, in the step S450, the audio remainder r and the first remainder N are still not processed, and therefore in steps S455˜S475, the remainders are processed. First, the audio remainder r is processed. After the step S450, whether or not i equals to fr*n+1 is judged (step S455). Now, since i=1, and n=0, i is then judged to be 10*0+1 in the step S455, namely, a judgement result of the step S455 is affirmative. Next, the audio remainder r is accumulated to a total remainder R (step S460). In other words, the step S460 may be represented by a mathematic equation R=R+r. Since R is set to 0 in the step S445, after the step S460 is executed, the total remainder R then equals to 5, and step S465 is executed.

Here, since the frame rate fr=10, the value of n is then added with 1 every 10 frames, i.e. every one second. If the audio remainder per second is not neglected, every one second, i.e. i=1, 11, 21, 31, . . . , fr*n+1, an audio remainder r is then generated. Therefore, when the judgement result of the step S455 is affirmative, the audio remainder r is then added to the total remainder R, and the total remainder R is processed by follow-up steps of the present embodiment. Conversely, if the judgement result of the step S465 is negative, the step S465 is then directly executed.

Next, in the step S465, whether or not O+(i−A)*N+R is greater than or equals to the rated value K is judged. Now, since O=0, i=1, A=0, N=92 and R=5, the judgement result of the step S465 is then negative, and step S480 is then directly executed, in which i=i+1 is performed, and then the step S450 is repeated. Now, i=2, namely, M=2 audio blocks are inserted between the second video block and the third video block. Next, since the judgement results of the steps S455 and S465 are all negative, the step S480 is directly executed, in which i=i+1 is performed, and when i=3, 4, 5, the steps thereof are all the same to the steps performed when i=2, and therefore the description thereof is not repeated.

However, when i=1, 2, 3, 4, 5, the first remainder N is still not processed in the above steps. Therefore, after M audio blocks are employed between each two video blocks, the first remainder N=92 is generated. In other words, if the first remainder N and the total remainder R are considered, the accumulated remainder generated between the i-th video block and the (i+1)-th video block is i*N+R. Therefore, the accumulated remainder i*N+R is now processed, wherein if i=6, in the step S465, O+(i−A)*N+R=0+(6−0)*92+5=557 is then judged to be greater than the rated value K=505. Namely, when the judgement result of the step S465 is affirmative, and the accumulated remainder is greater than the size of an audio block, M+1 audio blocks are then inserted between the i-th video block and the (i+1)-th video block (step S470), so as to compensate a part of the remainders. Namely, 3 audio blocks are now employed between a sixth video block and a seventh video block.

However, after the remainder compensation of the step S470, there are still remainders remained. Therefore, next, a remainder compensation position A=i is recorded and a second remainder O (i.e. the remainder remained after the compensation) is recorded, wherein O=O+(i−A)*N+R−K, and meanwhile the total remainder R is set to 0 (step S475). Next, the step S480 is executed, in which i=i+1 is performed. Deduced by analogy, after the steps S410˜S480 are performed, the audio blocks employed among all the video blocks are then obtained.

In summary, by applying the audio-video encoding method, the video chunk and the audio chunk within the audio-video file are divided into the plurality of small blocks, which is compatible to the present video format, so that memory volume of a follow-up circuit can be reduced, and video processing speed is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio-video encoding method comprising:
providing a video file;
reading a video chunk and a corresponding audio chunk from the audio-video file;
dividing the video chunk into a plurality of video blocks, wherein size of each of the video blocks at least equals to the size of one unit frame;
dividing the audio chunk into a plurality of audio blocks;
reading a sound sampling rate of the audio-video file;
reading a frame rate of the audio-video file;
calculating an audio configuration parameter, wherein the audio configuration parameter equals to the sound sampling rate divided by the frame rate;
determining a specific number of the audio blocks employed between each two video blocks according to a rated value of the audio blocks and the audio configuration parameter; and
employing the audio blocks with the specific number between each two video blocks according to a playing sequence.

2. The audio-video encoding method as claimed in claim 1, wherein method of dividing the video chunk into the plurality of video blocks comprises:
dividing the video chunk into the plurality of video blocks according to each frame of the video chunk.

3. The audio-video encoding method as claimed in claim 2, wherein the step of determining the specific number of the audio blocks employed between each two video blocks according to the rated value of the audio blocks and the audio configuration parameter comprises:
a. defining the rated value as K and the audio configuration parameter as L;
b. dividing L by K to obtain a quotient M and a first remainder N;
c. setting a remainder compensation position and a second remainder to 0;
d. inserting M audio blocks between an i-th video block and an (i+1)-th video block, and calculating i*N;
e. judging whether or not O+(i−A)*N is greater than K, wherein if yes, M+1 audio blocks are inserted between the i-th video block and the (i+1)-th video block, and the second remainder O=O+(i−A)*N−K is recorded, and the remainder compensation position A=i is recorded, and then step f. is executed; if not, the step f. is executed; and
f. adding 1 to i, and going back to the step d.

4. The audio-video encoding method as claimed in claim 1, wherein format of the encoded audio-video file is Microsoft AVI 2.0 format or AVI 1.1 format.

5. A multimedia storage apparatus, for storing an encoded audio-video file comprising a plurality of video blocks and a plurality of audio blocks, characterized in that:
one of the audio blocks is employed between each two video blocks, each of the video blocks contains the same number of frames, and audio data within each of the audio blocks is substantially equivalent to audio data corresponding to previous video block, wherein the encoded audio-video file further comprises:
a header, for recording setting data of the video blocks and the audio blocks; and
a plurality of indexes, for pointing to addresses of the video blocks and the audio blocks.

6. The multimedia storage apparatus as claimed in claim 5, wherein each frame is regarded as one of the video block.

7. The multimedia storage apparatus as claimed in claim 5, wherein format of the encoded audio-video file is Microsoft AVI 2.0 format or AVI 1.1 format.
